(19) United States
(12) Patent Application Publication
(10) Pub. No.: US 2025/0328962 A1
(43) Pub. Date: Oct. 23, 2025

(54) METHOD AND SYSTEM FOR FULLY AUTOMATED FULL SPECTRUM DYNAMIC EFFICIENT FRONTIER INVESTMENT ALLOCATION

(71) Applicant: ALLIO FINTECH CORPORATION, Seattle, WA (US)

(72) Inventors: Joseph Gradante, Oswego, OR (US); Raymond Charles Micaletti, JR., Humacao, PR (US); William Edward Chen, Aldie, VA (US); Lingfeng Chen, San Bruno, CA (US); Robert McLaughlin, Pensacola, FL (US)

(21) Appl. No.: 18/585,913

(22) Filed: Feb. 23, 2024

Related U.S. Application Data
(60) Provisional application No. 63/447,866, filed on Feb. 23, 2023.

(51) Int. Cl. G06Q 40/06

(52) U.S. Cl. CPC G06Q 40/06

(57) ABSTRACT

One or more disclosed embodiments solve the deficiencies with other previous round-ups to continue to leverage the change spread in transactions and allow them to be applied to micro-share investments, in both ETFs and tokens. It is the combination thereof of traditional, alternative and digital-currency products that gives one or more disclosed embodiments the ability to simplify the creation of an efficient frontier portfolio construction.

### PRIORITY CLAIM

This application claims priority to U.S. Provisional Application Ser. No. 63/447,866, filed Feb. 23, 2023, the entirety of which is hereby incorporated by reference as if fully set forth herein.

### COPYRIGHT NOTICE

This disclosure is protected under United States and/or International Copyright Laws.© 2024 All-Weather Fintech Corporation. All Rights Reserved. A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

Many existing approaches to automate investments have limitations. Acorns (https://www.acorns.com/), for instance, is limited to automated investments and round up investments in the equity and bond Exchange Traded Fund (ETF) fund space. Stash (https://www.stash.com/), offers equities, bonds and gold ETFs, but it isn't fully automated and doesn't have alternative assets like solar, wind, oil, gas ETFs, nor digital assets like Bitcoin, Ethereum, Litecoin, Monero or Crypto ETFs. RoundlyX (https://www.roundlyx.com/) offers investments in digital assets and currency only, like Bitcoin and Ethereum. Thus, the platform is extremely limited in scope and risk intense. The first two approaches rely on an antiquated investment model (Markowitz) that was developed in 1952 in a hawkish monetary environment and the third relies on purely speculative products. Therefore, there is a need for a new method and system that achieves optimal return capacity mitigated for risk.

### BRIEF DESCRIPTION OF THE DRAWINGS

Preferred and alternative examples of the present invention are described in detail below with reference to the following drawings:

FIG. 1 is a schematically illustrated overview of one or more embodiments; and

FIGS. 2-4 illustrate features of one or more embodiments of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices and can be used to implement or otherwise perform practical applications.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

In an embodiment, and by way of non-limiting example, a user accesses the investment platform via mobile or website application.¹ ¹ Mobile applications can be downloaded from app stores, like Apple App Store and Google Play. Other operating systems or interfaces may be used.

The user then creates an account, or logs into an existing account. If creating a new account, the user will go through an “onboarding” process that includes the following steps: risk profile & preferences questions, management method & portfolio selection, KYC/AML, funding process, then investment.

### Risk Profile and Preferences

The user is prompted to answer a series of questions to profile their investment risk tolerance and willingness subject to relevant regulatory standards.^{2 3} The answers to these questions are formulaically filtered into predefined risk profiles. This is a primary attribute for a user as it will impact portfolio recommendations.⁴ ² Sample questions include investment experience, goals for investing, available cash that will be invested, time horizon, etc.³ Questions are submitted and reviewed by the Financial Industry Regulatory Authority (FINRA).⁴ A user profile can be changed at any point in time with updated answers.

Additionally, a user is allowed the option to choose from a predetermined selection of social-values-based investments.⁵ These values will be directly included in their respective portfolio during portfolio selection. ⁵ Each social value has a corresponding underlying investment (e.g., ETF).

### Management Method & Portfolio Selection

The platform offers services for both managed & self-directed management methods based on user selection.

### Managed

By default, a pre-computed optimized portfolio (see Investment Engine) with all available asset class exposures is selected based on the user's risk profile. This will include an appropriate allocation to the aforementioned values.⁶ This is displayed to the user for acceptance. ⁶ Based on the social values selected, the Values asset class will be re-scaled to include the corresponding social value investment.

Managed portfolios will be monitored and rebalanced on an ongoing basis (see Ongoing).

### Self-Directed

A user can also choose to construct their own portfolio. This includes searching through a provided product list, aggregating a list of assets, and assigning weights to each (summing to 100%).

Additional functionality provided by the platform includes analyses of the portfolio chosen (see Radar).

### Funding Process

### Investment

At this point, once a user has selected a desirable portfolio, has been properly verified, and has successfully funded their account, the system invests the user's funds according to the selected portfolio. The disclosed system makes (fractional) purchases by communicating with a partnered clearing firm, stock, or other appropriate mediums of exchange.

### Ongoing

The system also constantly monitors users' portfolios for appropriate adjustments, including rebalancing. In addition to set calendar frequency rebalances, thresholds are set on user accounts⁷ that trigger a dynamic rebalance of the portfolio back to target weights. Thresholds can include, but are not limited to, weight differences or elevated contribution to expected risk. ⁷ A user can opt-out of these settings if not desirable.

### Stability-Adjusted Portfolios (SAP)

The process of portfolio optimization typically involves maximizing a measure of reward with respect to a measure of risk. A common risk measure, particularly in mean-variance optimization, is based on the covariance (i.e., co-movement) of assets in a portfolio using historical returns over long time horizons (e.g., five to twenty years).⁸ ⁸ https://www.investopedia.com/terms/m/meanvariance-analysis.asp

The resulting long-horizon covariances (summarized in matrix form) are structurally long-term averages, washing away any periodic fluctuations over shorter, intra-period time horizons (e.g., one year, three years, etc.). However, these shorter-term deviations are usually of interest from a “risk-focused” portfolio construction perspective.

As an example, over the past several decades the covariance between equities and bonds is negative. However, there have been several periods where the covariance between equities and bonds has been positive—and we may be heading into a secular macroeconomic environment where such covariances are the norm rather than the exception.⁹ If only the long-term negative covariances were used, the portfolio optimization procedure would overlook such positive-covariance outcomes, which may ultimately leave the portfolio vulnerable to larger-than-estimated losses should such relationships materialize (again). ⁹ https://russellinvestments.com/us/blog/is-the-stock-bond-correlation-positive-or-negative

Risk is unstable. The covariance relationships between assets are dynamic, not static. This should be considered when building portfolios.

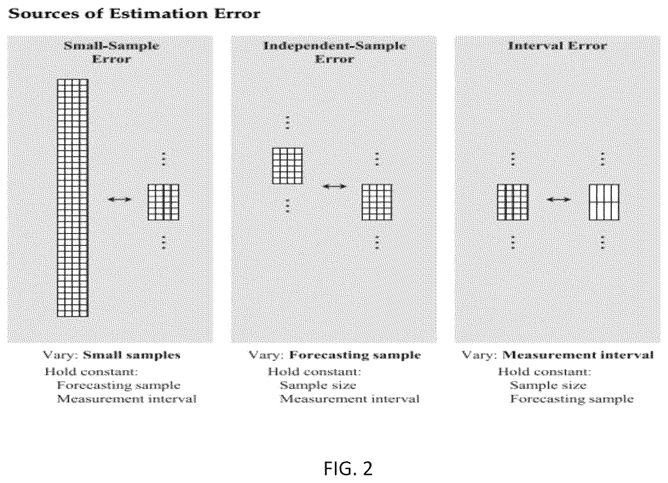

Using long-horizon covariance matrices introduces several sources of estimation error. The three primary sources (illustrated in FIG. 2) of estimation error are:
Small-sample error—when covariances from long historical samples are used to forecast covariances over shorter future time horizons. While the long-sample covariances may represent steady-state relationships, the actual covariances over shorter horizons could be materially different.
Independent-sample error—when the covariances from one (historical) sample are projected onto another independent sample (e.g., the future).
Interval error—when covariances computed using, say, monthly returns are different from covariances at yearly or multi-year horizons.

“Stability-adjusted portfolios” (SAP) is a process by which these sources of error are directly incorporated into the portfolio construction process, as opposed to being suppressed by using only one long-sample covariance matrix.¹⁰ ¹⁰ https://jpm.pm-research.com/content/42/5/113

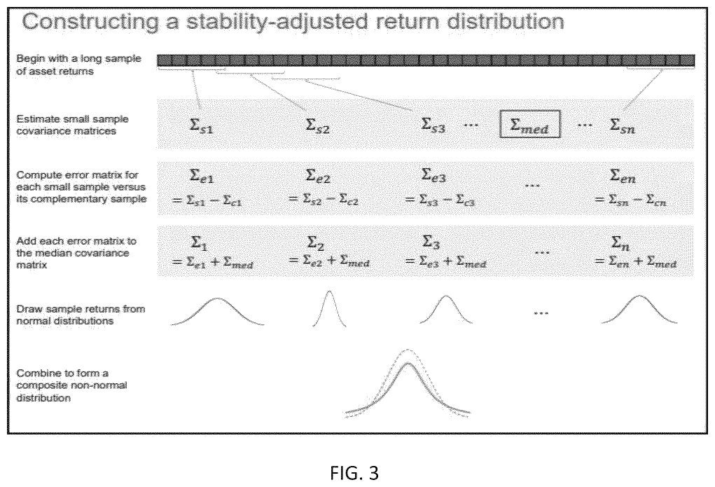

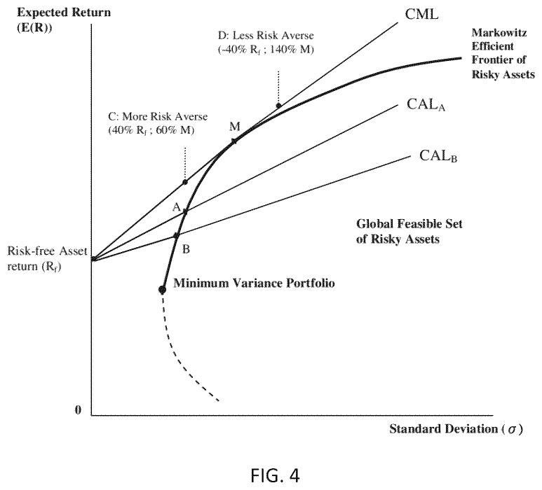

The basic SAP algorithm (illustrated in FIG. 3) is as follows:
Select a large sample of returns for the assets under consideration (e.g., monthly returns since 2000).

Select a subsample of this large sample and compute its covariance matrix based on returns of the same interval as the desired investment horizon. We choose a subsample of 60 months (i.e., 5 years) and an investment horizon of 12 months. Thus, we compute the subsample covariance matrix using 60 overlapping samples of 12-month returns.

Take the monthly returns from the large sample that were not used in the subsample and compute the covariance matrix using those monthly returns. (Note: we scale this to the same horizon as the subsample covariance matrix by multiplying by 12.)

Subtract the subsample covariance from the remaining large-sample covariance. The differences between them represent a composite error that incorporates small-sample error (because the subsample is smaller than the original sample), independent-sample error (because each subsample is distinct from the remaining observations in the original sample), and interval error (because the subsample interval is different from the original sample interval).

Slide the subsample window forward by some interval (e.g., one month) and repeat the procedure.

Continue until we have done this for all overlapping subsamples.

Take the errors (i.e., the differences in the subsample and remaining-sample covariances) found for each subsample and add those to a baseline covariance matrix (e.g., we use the average of all the subsample covariance matrices).

For each error-adjusted covariance matrix (i.e., for each average covariance matrix perturbed by the error from one subsample), generate simulated multivariate normal returns over the desired investment horizon, using expected return estimates in conjunction with the error-adjusted covariance matrix.

If there are N subsamples, and therefore N error-adjusted covariance matrices, there will be N sets of simulated returns. We pool these sets of simulated returns into one large sample (i.e., a “stability-adjusted return sample”).

Notably, this large sample of returns is non-normally distributed, with fatter tails than a normal distribution. As a result, it should better correspond to actual financial market returns.

The preceding algorithm is the general SAP procedure. Unfortunately, all assets under consideration may not have the same “history” of returns (since inception). For assets that lack a full history (“stubs”), we modify the algorithm in the following manner:

Check that the asset has enough history to meet certain statistical requirements.

Over the period for which the stub asset has data, compute the errors outlined by the general SAP algorithm.

For the periods in which the stub asset does not have data, estimate its covariance errors using a regression approach. First, take the stub asset's actual covariance errors (for which it has data) and regress them against the actual errors of the other assets. This fitted regression relationship is then used to estimate the errors of the stub asset over the time periods for which it does not have data (but for which the regressors do have data).

This approach is facilitated by ordering the stub assets based on the lengths of their respective histories, from longest to shortest. Thus, each sequential stub asset estimates its covariance errors from assets with longer time histories than itself.

For a stub asset whose historical data does not meet the relevant statistical requirements in terms of length (e.g., a recently released ETF), we take the average covariance matrix and add randomly generated errors from a uniform distribution to arrive at the pairwise covariance errors for the stub asset with every other asset, subject to certain constraints.

These SAP realizations are then used in our full-scale optimization procedure.

### Full-Scale Optimization

Full-scale optimization (FSO) is a simulation-based technique that offers two main advantages over standard mean-variance optimization (MVO):
FSO considers the entire joint distribution of asset returns, including any “fat tails” or hypothetical scenarios, when arriving at optimal allocations. In contrast, MVO assumes the means and covariances perfectly explain the entire joint return distribution—which is empirically false with respect to financial market returns.

FSO allows for any type of utility function—which allows for more realistic, behavioral-based functions—compared to the quadratic utility function implicit in MVO.

Thus, FSO is structurally able to construct portfolios that are explicitly robust to various downside possibilities. We use FSO in conjunction with our stability-adjusted returns procedure to leverage non-normal, fat-tailed joint distributions of asset returns. This results in portfolios constructed to better withstand the potential downside scenarios inherent in those simulated returns.

MVO, on the other hand, uses risk measures (i.e., covariances) that underestimate the probability of large moves (both up and down)--and thus doesn't directly subject the portfolio to such moves when determining what the optimal allocations are.

In this sense, FSO is a more risk-focused approach to portfolio optimization. Researchers have compared the results of FSO to MVO and have found that FSO outperforms MVO a higher percentage of the time out of sample.

Our FSO procedure is as follows:
Generate the SAP realizations for the assets in our investable universe covering the following exposures:
   Equities
   Fixed Income
   Gold
   Commodities
   Real Estate
   Factors (e.g., Value, Momentum, Dividends)
   Innovation (e.g., Next Generation Nasdaq 100)
   Blockchain
   Values (e.g., renewable energy, minority empowerment, etc.)

Compute all combinations of 5 or more asset classes (resulting in 256 different asset-class combinations).

Designate 5 different risk levels and a target volatility for each level:
Conservative—6%
Moderately conservative—9%
Moderate—12%
Moderately aggressive—15%
Aggressive—18%

For each asset class combination and risk level (256 combos×5 risk levels=1280 cases), run the SAP realizations through a differential evolution optimization function (a “smart” grid-search algorithm).

The objective function in the optimization is constructed to maximize the expected return relative to the expected shortfall (also known as the conditional value-at-risk). This metric seeks to maximize the return with respect to the expected loss should the portfolio fall below a threshold level.

The objective function also subjects the portfolio allocations to certain constraints, such as:
Bounds on the individual asset allocations
Bounds on the asset-class allocations
Minimum bounds on the volatility, such that each risk level hits its target volatility
Upper bounds on how much each asset can contribute to the expected shortfall as a percentage of an equal-weighted contribution (this helps to avoid a concentrated portfolio).
Run the differential evolution algorithm until it converges. If it fails to converge, the engine will automatically incrementally loosen the constraints described above until it does converge. For example, constraints that are originally too “tight” might prevent our target volatility from being met for the aggressive risk level, especially if the asset class combination contains low volatility asset classes.
Once complete, store the optimal allocations for each run with relevant metadata.

### Metadata

Our optimization process for a single portfolio by design considers if portfolio “candidates” (potential allocations) are meeting certain criteria/constraints (e.g., volatility level, asset weight limits, etc.). If not, then that candidate score is “penalized”—and unlikely to be the ultimate result if not completely excluded from consideration. Certain constraints are “hard” (e.g., expected volatility; will be completely excluded if not met) vs. “soft” (e.g., asset class weights; will be penalized but not a significant issue).

Our optimization process is looking to find the “optimal” solution—which by definition will maximize expected return/risk and limit penalties.

Even though the process itself is self-aware of “exceptions”, we also store “metadata” alongside the outputs for each run for further analysis. Some of this data includes an overall “success” flag (did a reasonable solution get met?), the score of the output (how good was the solution?), what's the expected volatility, how many iterations did it take to solve, and many other contextual data points.

This allows for seamless production integration (as we will not introduce any sub-optimal results that did not meet expectations into production) and easy exception reporting for further analyses (i.e., query all outputs that “failed”).

### Exception Reporting

From a technical standpoint we have an orchestrator (“pipeline”) that is overseeing the portfolio computation processes. Within the pipeline, we are constantly 1) collecting data to make sure the system is running correctly, and 2) storing parameters and other variables used for each run.

The data for #1 ranges from informational (timestamps, steps completed, etc.) to exceptions (warnings, critical errors, etc). Warnings include non-fatal issues like compute strain and package deprecation, while critical errors are system failures that prevent the process from completing. This information is logged and can be used for real-time alerts, post-processing analysis, and other QA processes to relevant parties (e.g., the Investment Committee).

We leverage #2 so we can recreate the processes and results from a specific run. This is useful for several purposes, including compliance and debugging issues.

A self-directed user will create their own investment portfolio by selecting a list of assets from a provided product list (currently of ETFs and publicly traded equities) and assigning corresponding weights. Given this portfolio, we can run real-time analytics on the portfolio to identify potential areas for the user to enhance the construction of their portfolio. These checks, alerts, and the analytics engine are collectively referred to as “Radar”.

### Efficient Frontier

The efficient frontier is a core representation of modern portfolio theory that, given an investable universe of assets, there are portfolios that maximize expected returns for a given level of expected risk. The “frontier” curve is composed of these individual points (portfolios).

In our case, the user selects the investable universe—the assets they want to include in their portfolio. From there, we can compute an efficient frontier using basic assumptions based on a full-scale portfolio generated by our investment engine.

Because each portfolio on the frontier is an investable portfolio (some combination of assets with weights ranging from 0-100%), we can make the portfolios (represented as circles on the curve) interactive and allow the user to select a portfolio on the efficient frontier if they so choose. Similarly, we can plot the user's selected portfolio with respect to the frontier to give an indication if potential improvements could be made to the composition of their portfolio (i.e., if it lies below the frontier).

### Single Stock Concentration

Exchange Traded Funds (ETFs) are useful investment vehicles to get diversified exposure (as opposed to picking individual stocks). However, if a user is combining multiple ETFs in their portfolio without appropriately examining the underlying holdings in a holistic view, this could potentially lead to pockets of risk in the portfolio, including single stock concentration.

Here is a simple example. Let's assume part of a user's portfolio holds 40% in iShares Global 100 ETF (IOO) and 40% in iShares US Tech ETF (IYW). At first glance, nothing is glaringly problematic-the user has global equity exposure with a focus on US Tech. But, if these ETFs are broken down into their individual holdings (i.e., “look thru”), there are large weightings of Apple (APPL), Microsoft (MSFT), and Alphabet (GOOG) in each ETF—so much so that almost ⅓ of the portfolio is in these 3 names alone.

Perhaps this is an intentional choice, but the user can still be alerted just in case. This check involves taking the user's holdings, for each ETF getting the underlying holdings, and grouping the portfolio by individual assets. If some number of securities exceeds a specified percentage threshold, then we can notify the user.

### Risk Congruence

Another check is to measure risk congruence—does the investor's risk profile match the expected risk of the portfolio chosen? If a user has a relatively conservative (non-risky) profile but the portfolio they selected has a high level of expected risk, there may be some potential dissonance that the user is unaware of.

This check is to simply calculate the expected risk of the given portfolio and compare it to their risk profile. If there is a large difference, then we can notify the user.

The following characteristics of a user's portfolio can be tested against the efficient frontier:
The portfolio's expected return
The portfolio's expected volatility
The portfolio's expected shortfall

If the characteristics closely match those of the frontier, then the risk congruence is acceptable. This is because the efficient frontier portfolio is generated based on the risk tolerance profile of the user.

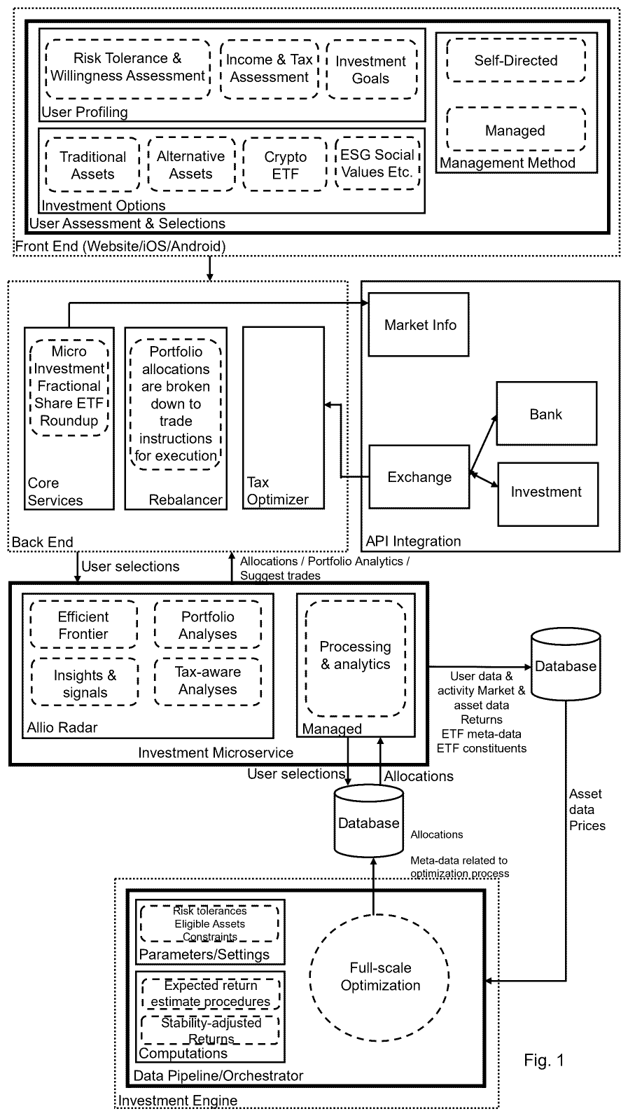

The attached FIG. 1 is a schematically illustrated overview of how the above-described processes flow and interact with one another.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A computer-implementable method of automatically constructing an efficient frontier investment portfolio investment allocation, the method comprising the steps of:
compiling an electronic history comprising:
(a) at least one identifier of an investor and
(b) data identifying the investor's investment preferences and risk tolerance;
storing said electronic history in a memory device;
generating to a display device a user interface within which is displayed input fields for the user to input said investor investment preferences and risk tolerance;
receiving from the user, via the user interface and user input fields, a selection of a first investor preference and tolerance;
in response to the selection of the first preference and tolerance, computing an efficient frontier for a portfolio composition across a full spectrum of possible investments;
generating to a display device a view of portfolio parameters and investments along said efficient frontier;
displaying in the user interface a field for the investor to select investments representing investment options corresponding to the efficient frontier; and
wherein the preceding steps are performed by at least one processor.
